(19) United States
(12) Patent Application Publication
(10) Pub. No.: US 2026/0105904 A1
(43) Pub. Date: Apr. 16, 2026

(54) SOUND INSULATOR FORMED OF MODIFIED KELVIN-14 MATERIAL

(71) Applicant: NISSAN NORTH AMERICA, INC., Franklin, TN (US)

(72) Inventors: Takuro IWATA, Commerce Township, MI (US); Nanzhu ZHAO, Novi, MI (US); Sandeep PATIL, Farmington Hills, MI (US)

(21) Appl. No.: 18/912,336

(22) Filed: Oct. 10, 2024

(51) Int. Cl. G10K 11/162

(52) U.S. Cl. CPC G10K 11/162

(57) ABSTRACT

A sound insulator is provided. The sound insulator includes a plurality of structures Each of the plurality of structures includes a plurality of interconnected wires and a modified surface. The plurality of interconnected wires forms a shape having faces. The modified surface covers at least one of the faces. The modified surface includes at least one selected from the group consisting of: a plurality of holes that extend through an entirety of a thickness of the modified surface, and a mass damper having a greater thickness than the thickness of the modified surface.

### BACKGROUND

### Field of the Invention

The present invention generally relates to a sound insulator for an engine, in particular a sound insulator formed of a modified Kelvin-14 material. The present invention relates specifically to a sound insulator that includes a plurality of structures. Each of the plurality of structures includes a plurality of interconnected wires and a modified surface. The plurality of interconnected wires form a polyhedron shape having faces. The modified surface covers at least one of the faces. The modified surface includes at least one selected from the group consisting of: a plurality of holes that extend through an entirety of a thickness of the modified surface, and a mass damper having a greater thickness than the thickness of the modified surface.

The present invention also relates to a sound insulator in which at least one of the plurality of interconnected wires is a first wire having a roughened surface that includes at least one of: a plurality of raised portions and a plurality of concave portions. The present invention further relates to a sound insulator in which at least one of the plurality of interconnected wires is a second wire having a plurality of holes that extend through an entirety of a diameter of the second wire.

### Background Information

Electric vehicles (“EVs”) that use an electric motor powered by rechargeable batteries (“e-Powertrain”) are an alternative to hybrid or traditionally fueled vehicles that include an internal combustion engine powered by gasoline. EVs have gained a lot of attention in recent years as the focus on environmentally friendly technologies has amplified. Furthermore, it is desirable to downsize the e-Powertrain of the EVs to save space and material. However, the downsizing of the e-Powertrain creates more noise from the gearbox. Thus, there is a need for a sound insulator to absorb the excess noise from the gearbox.

In order to absorb the noise generated by these downsized e-Powertrains, typical fiber and foam materials have conventionally been used. These conventional insulator materials have a random structure and, thus, randomly insulate sound generated by the e-Powertrain. Therefore, these traditional insulating materials are insufficient to absorb the excess noise generated by modern downsized e-Powertrains.

Therefore, further improvement is needed to develop a sound insulator that more reliably and sufficiently absorbs the noise generated by e-Powertrains of EVs. In particular, it is desirable to provide a material that has a less random structure and a more uniform, ordered structure that efficiently absorbs sound without being too thick or taking up too much space in the EVs.

### SUMMARY

It has been discovered that the noise generated by the e-Powertrain can be better absorbed by providing an insulator material having a modified Kelvin-14 structure. In particular, it has been discovered that sound can be better absorbed by an insulator that is formed of a plurality of structures each having a Kelvin-14 structure that has been modified to increase the friction surface area of the structure. By increasing the friction surface area of the structures, the sound can be better absorbed as it propagates through the material. The sound insulator can be formed by a three dimensional printing process.

In view of the state of the known technology, one aspect of the present disclosure is to provide a sound insulator that includes a plurality of structures. Each of the plurality of structures includes a plurality of interconnected wires and a modified surface. The plurality of interconnected wires form a shape having faces. The modified surface covers at least one of the faces. The modified surface includes at least one selected from the group consisting of: a plurality of holes that extend through an entirety of a thickness of the modified surface, and a mass damper having a greater thickness than the thickness of the modified surface.

By providing the modified surface covering at least one of the faces of the structures, the friction surface area of the sound insulator can be increased. As a result, sound can be better absorbed as it propagates through the material when compared to conventional sound insulators.

Another aspect of the present disclosure is to provide a sound insulator that includes a plurality of structures. Each of the plurality of structures includes a plurality of interconnected wires forming a shape having eight hexagonal faces and six square faces. At least one of the plurality of interconnected wires is a first wire having a roughened surface that includes at least one of: a plurality of raised portions and a plurality of concave portions. Each of the plurality of interconnected wires is formed of a photopolymerizable resin material.

A further aspect of the present disclosure is to provide a sound insulator that includes a plurality of structures. Each of the plurality of structures includes a plurality of interconnected wires forming a shape having eight hexagonal faces and six square faces. At least one of the plurality of interconnected wires is a second wire having a plurality of holes that extend through an entirety of a diameter of the second wire. Each of the plurality of interconnected wires is formed of a photopolymerizable resin material.

By providing the first wire having the roughened surface or the second wire having the plurality of holes, the friction surface area of the sound insulator can be increased. As a result, sound can be better absorbed as it propagates through the material when compared to conventional sound insulators.

### BRIEF DESCRIPTION OF THE DRAWINGS

Referring now to the attached drawings which form a part of this original disclosure:

FIG. 1a is a perspective view of a sound insulator including a plurality of structures according to a first embodiment;

FIG. 1b is an enlarged perspective view of one of the plurality of structures according to the first embodiment;

FIG. 2a is a perspective view of a sound insulator including a plurality of structures according to a second embodiment;

FIG. 2b is an enlarged perspective view of one of the plurality of structures according to the second embodiment;

FIG. 2c is a cross-sectional view of a wire of one of the plurality of structures according to the second embodiment

FIG. 3a is a perspective view of a sound insulator including a plurality of structures according to a third embodiment;

FIG. 3b is an enlarged perspective view of one of the plurality of structures according to the third embodiment;

FIG. 3c is a cross-sectional view of a surface of one of the plurality of structures according to the third embodiment;

FIG. 4a is a perspective view of a sound insulator including a plurality of structures according to a fourth embodiment;

FIG. 4b is an enlarged perspective view of one of the plurality of structures according to the fourth embodiment;

FIG. 4c is a cross-sectional view of a surface of one of the plurality of structures according to the fourth embodiment;

FIG. 5a is a side view of a printer assembly having a textured window according to a fifth embodiment;

FIG. 5b is a partial enlarged cross sectional view of the printer assembly having the textured window of FIG. 5a;

FIG. 6 is a perspective view of a plurality of structures for a sound insulator according to a sixth embodiment; and

FIG. 7 is a cross-sectional view of an engine system of a vehicle according to a seventh embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

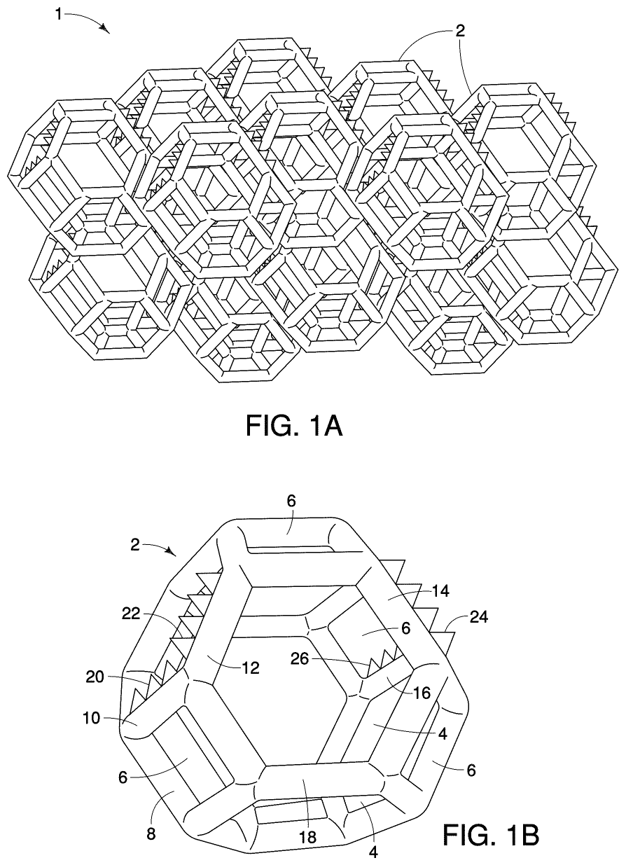

Referring initially to FIG. 1a, a sound insulator l is illustrated in accordance with a first embodiment. The sound insulator 1 can be used to insulate sound in any suitable device, such as a vehicle, a building, machinery or appliances such as an air conditioning unit or a HVAC. For example, the sound insulator 1 can be used in an e-Powertrain for an EV. The sound insulator 1 can have any suitable thickness. For example, the sound insulator 1 has a thickness of 1 mm to 100 mm, preferably 5 mm to 30 mm.

As shown in FIG. 1a, the sound insulator 1 has an ordered structure and includes a plurality of structures 2. The plurality of structures 2 are formed of a resin. The resin can be any suitable resin used in a three dimensional printing process. The resin is preferably a photopolymerizable resin that can be polymerized by light such as ultraviolet light. In particular, the photopolymerizable resin can be formed of: a nylon having a photoinitiator wavelength of 290-315 nm, an acrylic having a photoinitiator wavelength of 290-315 nm, a styrene acrylonitrile having a photoinitiator wavelength of 290-330 nm, a polycarbonate having a photoinitiator wavelength of 280-310 nm, a polystyrene having a photoinitiator wavelength of 310-325 nm, a polyethylene having a photoinitiator wavelength of 300-340 nm, a polypropylene having a photoinitiator wavelength of 290-370 nm, an acrylonitrile butadiene styrene (“ABS”) photopolymer having a photoinitiator wavelength of 300-385 nm, a polyvinyl chloride (“PVC”) homopolymer having a photoinitiator wavelength of approximately 320 nm, a PVC copolymer having a photoinitiator wavelength of 330-370 nm, a polyurethane (aromatic) having a photoinitiator wavelength of 350-415 nm, or a mixture thereof.

As shown in FIG. 1b, each of the structures 2 has a polyhedron shape having eight hexagonal faces 4 and six square faces 6. The hexagonal faces 4 and the square faces 6 are open faces that are not bounded or closed. The structures 2 are formed by a plurality of interconnected wires 8. Each of the interconnected wires 8 are formed of the resin and have an average diameter of approximately 10 μm to 1,000 μm, preferably 10 μm to 500 μm.

The structures 2 can be separate structures that are stacked on top of each other. However, all the structures 2 could be included in a single, monolithic sheet of structures 2. In the monolithic sheet of structures 2, the wires 8 forming a hexagon side of a first structure are the same wires 8 that define a hexagon side of a second structure. And, in the monolithic sheet of structures 2, the wires 8 forming a square side of the first structure are the same wires that define a square side of a third structure.

The interconnected wires 8 include first wires 10, 12, 14 and 16 and second wires 18. The first wires 10, 12, 14 and 16 are roughened and include a plurality of respective raised portions 20, 22, 24 and 26. In contrast, second wires 18 do not include any raised portions. The raised portions 20, 22, 24 and 26 have a height above the surface of the first wires 10, 12, 14 and 16 such that at least one of a minimum diameter and a maximum diameter of each of the first wires 10, 12, 14 and 16 varies by at least 5% from an average diameter of the first wire. For example, the raised portions 20, 22, 24 and 26 can each have a height of approximately 0.5 μm to 50 μm.

In this embodiment, structure 2 includes four first roughened wires 10, 12, 14 and 16. However, it should be understood that any suitable number of first roughened wires can be provided, as long as there is at least one first roughened wire in the structure 2.

The sound insulator 1 can be formed by any suitable process. For example, the sound insulator 1 is formed by a three dimensional printing process. The first wires 10, 12, 14 and 16 having the roughened surface can be formed in any suitable manner as long as at least one of a minimum diameter and a maximum diameter of each of the first wires 10, 12, 14 and 16 varies by at least 5% from an average diameter of the first wire. For example, the roughened surface on the first wires 10, 12, 14 and 16 can be formed by intentionally overcuring the resin, adjusting the printing speed of the three dimensional printer, performing gray scale filtering during the three dimensional printing process, or changing a shape of a textured window in the three dimensional printer. In particular, the roughened surface on the first wires 10, 12, 14 and 16 can be formed by increasing the printing speed of the three dimensional printer to up to approximately 10 times the normal operating speed of the three dimensional printer. For example, the printing speed of the three dimensional printer can be increased from a normal operating speed of 0.5 mm/s to a speed of 2.5 mm/s. Alternatively, the roughened surface on the first wires 10, 12, 14 and 16 can be formed by changing the amount of power emitted from the light source in different parts of the interconnected wires 8.

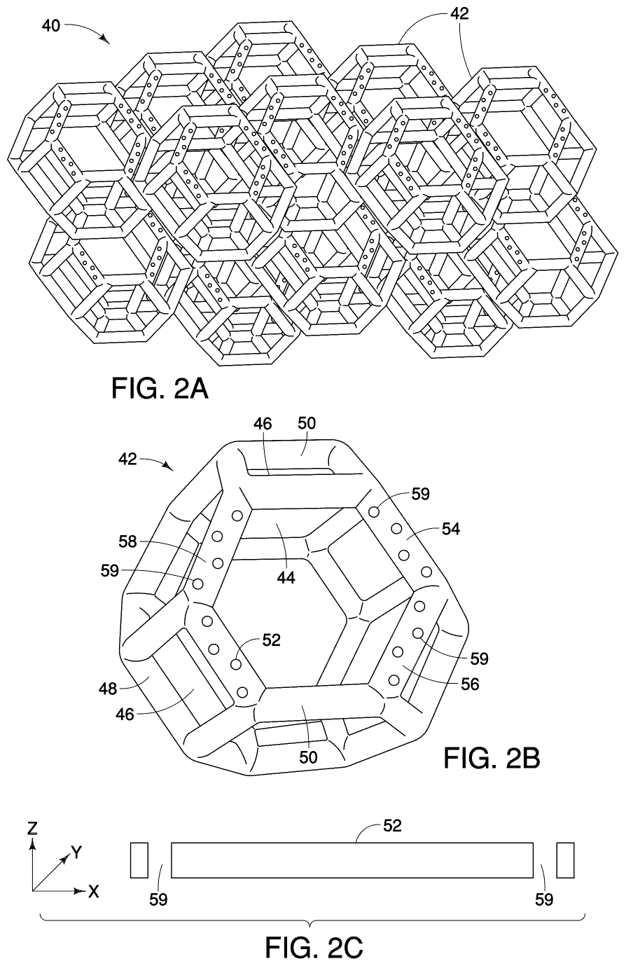

FIG. 2a shows a sound insulator 40 in accordance with a second embodiment. The sound insulator 40 can be used to insulate sound in any suitable device, such as a vehicle, a building, machinery or appliances such as an air conditioning unit or a HVAC. For example, the sound insulator 40 can be used in an e-Powertrain for an EV. The sound insulator 40 can have any suitable thickness. For example, the sound insulator 40 has a thickness of 1 mm to 100 mm, preferably 5 mm to 30 mm.

As shown in FIG. 2a, the sound insulator 40 has an ordered structure and includes a plurality of structures 42. The plurality of structures 42 are formed of a resin. The resin can be any suitable resin used in a three dimensional printing process. The resin is preferably a photopolymerizable resin that can be polymerized by light such as ultraviolet light. In particular, the photopolymerizable resin can be formed of: a nylon having a photoinitiator wavelength of 290-315 nm, an acrylic having a photoinitiator wavelength of 290-315 nm, a styrene acrylonitrile having a photoinitiator wavelength of 290-330 nm, a polycarbonate having a photoinitiator wavelength of 280-310 nm, a polystyrene having a photoinitiator wavelength of 310-325 nm, a polyethylene having a photoinitiator wavelength of 300-340 nm, a polypropylene having a photoinitiator wavelength of 290-370 nm, an ABS photopolymer having a photoinitiator wavelength of 300-385 nm, a PVC homopolymer having a photoinitiator wavelength of approximately 320 nm, a PVC copolymer having a photoinitiator wavelength of 330-370 nm, a polyurethane (aromatic) having a photoinitiator wavelength of 350-415 nm, or a mixture thereof.

As shown in FIG. 2b, each of the plurality of structures 42 has a polyhedron shape having eight hexagonal faces 44 and six square faces 46. The hexagonal faces 44 and the square faces 46 are open faces that are not bounded or closed. The structures 42 are formed by a plurality of interconnected wires 48. Each of the interconnected wires 48 are formed of the resin and have a diameter of approximately 10 μm to 1,000 μm, preferably 10 μm to 500 μm.

The structures 42 can be separate structures that are stacked on top of each other. However, all the structures 42 could be included in a single, monolithic sheet of structures 42. In the monolithic sheet of structures 42, the wires 48 forming a hexagon side of a first structure are the same wires 48 that define a hexagon side of a second structure. And, in the monolithic sheet of structures 42, the wires 48 forming a square side of the first structure are the same wires 48 that define a square side of a third structure.

The interconnected wires 48 include first wires 50 and second wires 52, 54, 56 and 58. The second wires 52, 54, 56 and 58 each include a plurality of holes 59. In contrast, first wires 50 do not include any holes. The holes 59 each have a size or diameter that ranges from 10% to 90% of a size or diameter of the second wires 52, 54, 56 and 58. For example, the holes 50 can each have a diameter of approximately 5 μm to 900 μm. The holes 59 extend through the entire diameter of the second wires 52, 54, 56 and 58 as shown in FIG. 2c.

In this embodiment, structure 42 includes four second wires 52, 54, 56 and 58 having holes 59. However, it should be understood that any suitable number of second wires having holes can be provided, as long as there is at least one second wire having holes in the structure 42.

The sound insulator 40 can be formed by any suitable process. For example, the sound insulator 40 is formed by a three dimensional printing process. The second wires 52, 54, 56 and 58 having the holes 59 can be formed in any suitable manner as long as the holes 59 extend through the entire diameter of each of the second wires 52, 54, 56 and 58 and each have a size or diameter that ranges from 10% to 90% of a size or diameter of the second wires 52, 54, 56 and 58. For example, the holes 59 can be formed by a three dimensional printing process in which gaps are formed along the second wires 52, 54, 56 and 58.

In this embodiment, structure 42 includes the second wires 52, 54, 56 and 58 having the holes 59 but does not include the roughened surface described in the first embodiment. However, it should be understood that the surfaces of any of the wires 48 can be roughened as described with respect to the sound insulator 1 of the first embodiment.

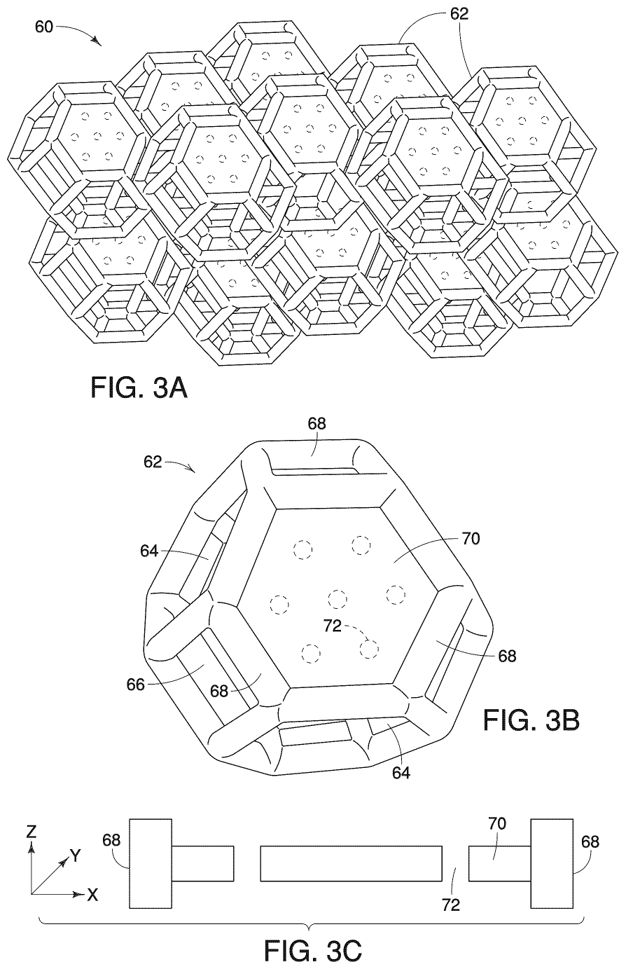

FIG. 3a shows a sound insulator 60 in accordance with a third embodiment. The sound insulator 60 can be used to insulate sound in any suitable device, such as a vehicle, a building, machinery or appliances such as an air conditioning unit or a HVAC. For example, the sound insulator 60 can be used in an e-Powertrain for an EV. The sound insulator 60 can have any suitable thickness. For example, the sound insulator 60 has a thickness of 1 mm to 100 mm, preferably 5 mm to 30 mm.

As shown in FIG. 3a, the sound insulator 60 has an ordered structure and includes a plurality of structures 62. The plurality of structures 62 are formed of a resin. The resin can be any suitable resin used in a three dimensional printing process. The resin is preferably a photopolymerizable resin that can be polymerized by light such as ultraviolet light. In particular, the photopolymerizable resin can be formed of: a nylon having a photoinitiator wavelength of 290-315 nm, an acrylic having a photoinitiator wavelength of 290-315 nm, a styrene acrylonitrile having a photoinitiator wavelength of 290-330 nm, a polycarbonate having a photoinitiator wavelength of 280-310 nm, a polystyrene having a photoinitiator wavelength of 310-325 nm, a polyethylene having a photoinitiator wavelength of 300-340 nm, a polypropylene having a photoinitiator wavelength of 290-370 nm, an ABS photopolymer having a photoinitiator wavelength of 300-385 nm, a PVC homopolymer having a photoinitiator wavelength of approximately 320 nm, a PVC copolymer having a photoinitiator wavelength of 330-370 nm, a polyurethane (aromatic) having a photoinitiator wavelength of 350-415 nm, or a mixture thereof.

As shown in FIG. 3b, each of the plurality of structures 62 has a polyhedron shape having eight hexagonal faces 64 and six square faces 66. The structures 62 are formed by a plurality of interconnected wires 68. Each of the interconnected wires 68 are formed of the resin and have a diameter of approximately 10 μm to 1,000 μm, preferably 10 μm to 500 μm. Seven of the hexagonal faces 64 and all of the square faces 66 are open faces that are not bounded or closed.

The structures 62 can be separate structures that are stacked on top of each other. However, all the structures 62 could be included in a single, monolithic sheet of structures 62. In the monolithic sheet of structures 62, the wires 68 forming a hexagon side of a first structure are the same wires 68 that define a hexagon side of a second structure. And, in the monolithic sheet of structures 62, the wires 68 forming a square side of the first structure are the same wires 68 that define a square side of a third structure.

One of the hexagonal faces 64 includes a closed, solid surface 70 having a plurality of holes 72. As shown in FIG. 3c, the surface 70 has a thickness that is smaller than the diameter of the wires 68 in the z-direction. The holes 72 each have a size or diameter that ranges from 10% to 90% of a size or diameter of the wires 68. For example, the holes 72 can each have a diameter of approximately 5 μm to 900 μm. The holes 72 extend through the entire thickness of the surface 70 as shown in FIG. 3c.

In this embodiment, structure 62 includes one surface 70 having holes 72. However, it should be understood that any suitable number of surfaces having holes can be provided, as long as at least one of the faces 64, 66 is an open face.

The sound insulator 60 can be formed by any suitable process. For example, the sound insulator 60 is formed by a three dimensional printing process. The surface 70 having the holes 72 can be formed in any suitable manner as long as the surface 70 has a smaller thickness than the wires 68 and the holes 72 extend through the entire diameter of the surface 70. For example, the holes 72 can be formed by a three dimensional printing process in which gaps are formed along the surface 70.

In this embodiment, structure 62 includes the surface 70 having the holes 72 but does not include the roughened surface described in the first embodiment or the wires having holes described in the second embodiment. However, it should be understood that the surfaces of any of the wires 68 can be roughened as described with respect to the sound insulator 1 of the first embodiment. It should also be understood that any of the wires 68 can have holes as described with respect to the sound insulator 40 of the second embodiment.

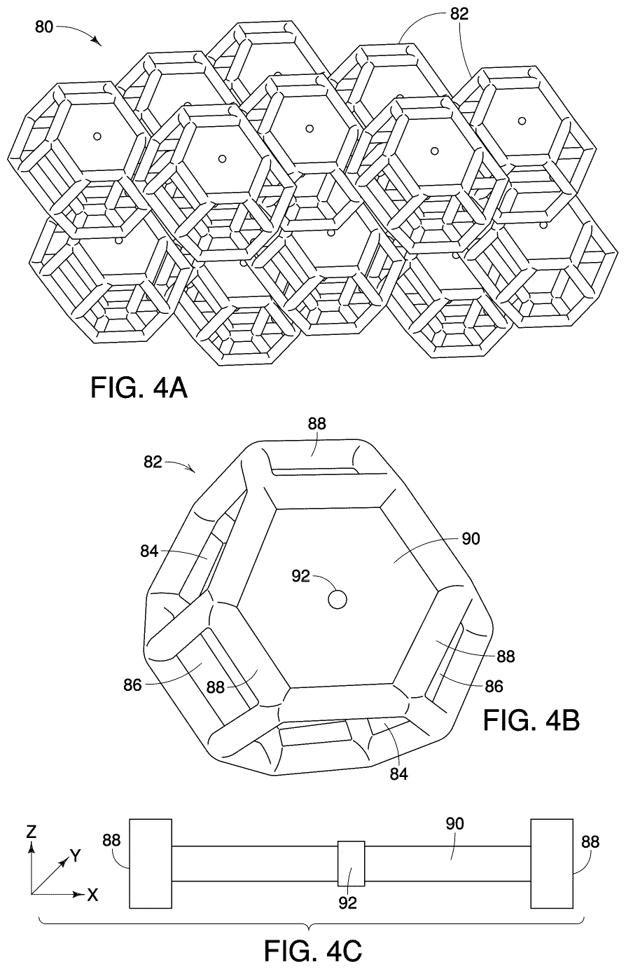

FIG. 4a shows a sound insulator 80 in accordance with a fourth embodiment. The sound insulator 80 can be used to insulate sound in any suitable device, such as a vehicle, a building, machinery or appliances such as an air conditioning unit or a HVAC. For example, the sound insulator 80 can be used in an e-Powertrain for an EV. The sound insulator 80 can have any suitable thickness. For example, the sound insulator 80 has a thickness of 1 mm to 100 mm, preferably 5 mm to 30 mm.

As shown in FIG. 4a, the sound insulator 80 has an ordered structure and includes a plurality of structures 82. The plurality of structures 82 are formed of a resin. The resin can be any suitable resin used in a three dimensional printing process. The resin is preferably a photopolymerizable resin that can be polymerized by light such as ultraviolet light. In particular, the photopolymerizable resin can be formed of: a nylon having a photoinitiator wavelength of 290-315 nm, an acrylic having a photoinitiator wavelength of 290-315 nm, a styrene acrylonitrile having a photoinitiator wavelength of 290-330 nm, a polycarbonate having a photoinitiator wavelength of 280-310 nm, a polystyrene having a photoinitiator wavelength of 310-325 nm, a polyethylene having a photoinitiator wavelength of 300-340 nm, a polypropylene having a photoinitiator wavelength of 290-370 nm, an ABS photopolymer having a photoinitiator wavelength of 300-385 nm, a PVC homopolymer having a photoinitiator wavelength of approximately 320 nm, a PVC copolymer having a photoinitiator wavelength of 330-370 nm, a polyurethane (aromatic) having a photoinitiator wavelength of 350-415 nm, or a mixture thereof.

As shown in FIG. 4b, each of the plurality of structures 82 has a polyhedron shape having eight hexagonal faces 84 and six square faces 86. The structures 82 are formed by a plurality of interconnected wires 88. Each of the interconnected wires 88 are formed of the resin and have a diameter of approximately 10 μm to 1,000 μm, preferably 10 μm to 500 μm. Seven of the hexagonal faces 84 and all of the square faces 86 are open faces that are not bounded or closed.

The structures 82 can be separate structures that are stacked on top of each other. However, all the structures 82 could be included in a single, monolithic sheet of structures 82. In the monolithic sheet of structures 82, the wires 88 forming a hexagon side of a first structure are the same wires 88 that define a hexagon side of a second structure. And, in the monolithic sheet of structures 82, the wires 88 forming a square side of the first structure are the same wires 88 that define a square side of a third structure

One of the hexagonal faces 84 includes a closed, solid surface 90 having a mass damper 92 in a center thereof. As shown in FIG. 4c, the surface 90 has a thickness that is smaller than the diameter of the wires 88 in the z-direction. The mass damper 92 has a substantially cylindrical shape but can have any suitable shape. The mass damper 92 has a depth in the z-direction that is greater than the thickness of the surface 90 but less than the diameter of the wires 88. Furthermore, the mass damper 92 has a size or diameter that ranges from 10% to 90% of a size or diameter of the wires 88.

In this embodiment, structure 82 includes one surface 90 having a single mass damper 92. However, it should be understood that any suitable number of surfaces having a mass damper or a plurality of mass dampers can be provided, as long as at least one of the faces 84, 86 is an open face.

The sound insulator 80 can be formed by any suitable process. For example, the sound insulator 80 is formed by a three dimensional printing process. The surface 90 having the mass damper 92 can be formed in any suitable manner as long as the surface 90 has a smaller thickness than the wires 88 and the mass damper 92 has both a thickness in the z-direction that is greater than the thickness of the surface 90 and a width or diameter in the x-direction that is less than 90% of the diameter of the surface 90. For example, the holes 92 can be formed on the surface 90 by a three dimensional printing process.

In this embodiment, structure 82 includes the surface 90 having the mass damper 92 but does not include the roughened surface described in the first embodiment, the wires having holes described in the second embodiment, or the surface having holes described in the third embodiment. However, it should be understood that the surfaces of any of the wires 88 can be roughened as described with respect to the sound insulator 1 of the first embodiment. It should also be understood that any of the wires 88 can have holes as described with respect to the sound insulator 40 of the second embodiment, and the structure 82 can have a surface having holes as described with respect to the sound insulator 60 of the third embodiment.

In the first through fourth embodiments, structures 2, 42, 62 and 82 have a polyhedron shape having eight hexagonal faces and six square faces. However, it should be understood that the structures 2, 42, 62 and 82 can have any suitable polyhedron shape.

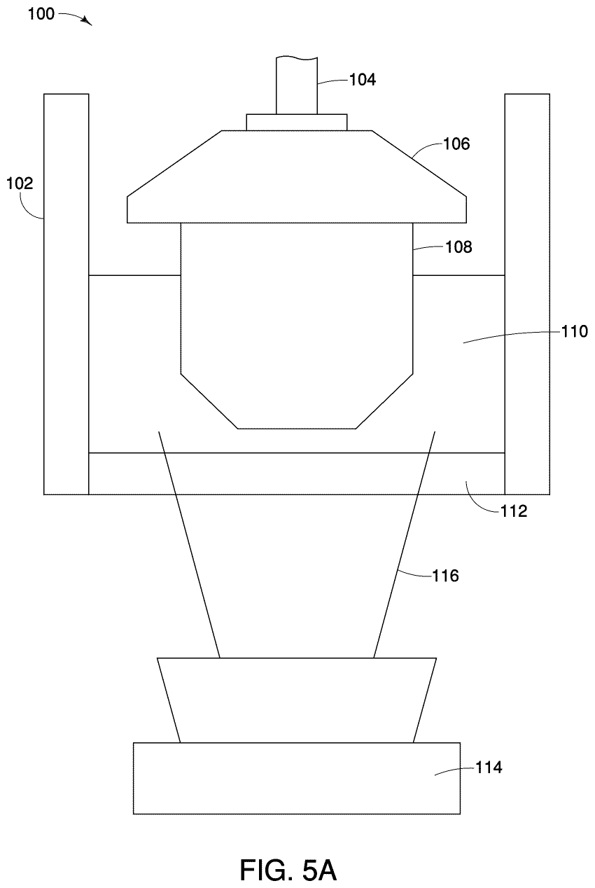

FIG. 5a shows a three dimensional printer assembly 100 for producing a sound insulator according to a ninth embodiment. The sound insulator includes a plurality of repeating structures. The structures of the sound insulator can be any of the structures described in the first to fourth embodiments.

As shown in FIG. 5a, the printer assembly 100 includes a tank 102, a robotic arm 104 and an object carrier 106 connected to the robotic arm 104. The object carrier 106 is configured to carry an object 108 that is printed by the printer assembly 100. The tank 102 includes a resin 110 and a textured window 112. The printer assembly 100 also includes a resin curing device 114 that emits ultraviolet light 116. A more detailed description of each of these portions of the printer assembly 100 is provided after a brief overview of the basic functions of these features.

As is also shown in FIG. 5a, during operation of the printer assembly 100, the tank 102 is at least partially filled with the resin 110. The resin 110 can be any suitable resin for a three dimensional printer assembly. For example, the resin 110 can be any suitable polymerizable resin, such as a photopolymer resin that is polymerized by the ultraviolet light 116. The resin 110 is preferably a photopolymer resin. In particular, the resin 110 can be formed of: a nylon having a photoinitiator wavelength of 290-315 nm, an acrylic having a photoinitiator wavelength of 290-315 nm, a styrene acrylonitrile having a photoinitiator wavelength of 290-330 nm, a polycarbonate having a photoinitiator wavelength of 280-310 nm, a polystyrene having a photoinitiator wavelength of 310-325 nm, a polyethylene having a photoinitiator wavelength of 300-340 nm, a polypropylene having a photoinitiator wavelength of 290-370 nm, an acrylonitrile butadiene styrene ABS photopolymer having a photoinitiator wavelength of 300-385 nm, a polyvinyl chloride PVC homopolymer having a photoinitiator wavelength of approximately 320 nm, a PVC copolymer having a photoinitiator wavelength of 330-370 nm, a polyurethane (aromatic) having a photoinitiator wavelength of 350-415 nm, or a mixture thereof.

The resin 110 flows freely into the printing area P during the operation of the printing assembly 100, as is described in greater detail below. The resin 110 can be supplied to the tank 102 such that the resin fills most or all of the interior volume of the tank 102, depending upon the object 108 being printed and the anticipated volume of use of resin needed to print the object 108 being printed by the printer assembly 100.

The textured window 112 is a structure formed at the bottom of the tank 102 as shown in FIG. 5a. The textured window 112 can be connected to the bottom of the tank 102 in any suitable manner or can be formed integrally with the bottom of the tank 102. The tank 102 can be manufactured of any suitable material, such as a plastic, a polymer, a metallic material, or mixtures thereof.

The textured window 112 has a total thickness of approximately 10 μm to 5 cm. The textured window 112 is optically transparent and has an ultraviolet light transmittance of at least 60%, preferably at least 90%, such that focused beams of light from the resin curing device 114 pass therethrough and at predetermined areas or portions of the polymerizable resin located within the printing area P.

The resin curing device 114 is installed or located below the tank 102 and is positioned to selectively project light upward through transparent textured window 112 of the tank 102. An electronic controller (not shown) controls operation of the resin curing device 114 to cure and harden the polymerizable resin 110 located within the printing area P in order to form the object 108. The resin curing device 114 can be any of a variety of resin curing light sources such as an ultra-violet projector, laser (stereolithography) digital light projector, liquid crystal display, projector or other light emitting device capable of electronic focusing and imaging focused light in order to selectively cure polymerizable resin to form the object 108.

The printing area P is defined as being the space below the object carrier 106 (at and/or below a lower surface of the object 108 being printed). Further, the printing area P is preferably located above and spaced apart from the textured window 112 but can be in contact with the textured window 112.

As shown in FIG. 5b, the textured window 112 is a substrate formed of any suitable optically transparent material. For example, the textured window 112 can be made of any suitable transparent material, such as plexiglass, traditional glass, any suitable transparent plastic or polymer material, or a mixture thereof. Preferably, the textured window 112 is made of a glass material. The textured window 112 has a thickness of approximately 9 μm to 3 cm. The textured window 112 also includes a plurality of shapes 118, 120, 122, 124 and 126 through which light from the resin curing device 114 is emitted.

The printer assembly 100 can print a sound insulator according to the first through fourth embodiments. In particular, the printer assembly 100 can print a sound insulator having at least one wire with a roughened surface according to the first embodiment by increasing the printing speed of the printer assembly 100 up to 10 times the normal operating speed of the three dimensional printer. For example, the printing speed of the printer assembly can be increased from a normal operating speed of 0.5 mm/s to a speed of 2.5 mm/s.

In addition, the roughened surface can be generated by providing shapes 118, 120, 122, 124 and 126 having varying geometry on the textured window 112. Alternatively, the roughened surface on the first wire(s) can be formed by performing gray scale printing on the object 108. In this regard, the resin curing device 114 can emit light at a different power amount in the different printing areas P1 and P2 of the printing area P. For example, as shown in FIG. 5b, the printing area P1 can be a low power printing area at the edges of the printing area P, and the printing area P2 can be a high power central printing area of the printing area P. The power in printing area P1 can be approximately 50% of the full power during normal use, whereas the power in printing area P2 can be approximately 100% of the full power during normal use.

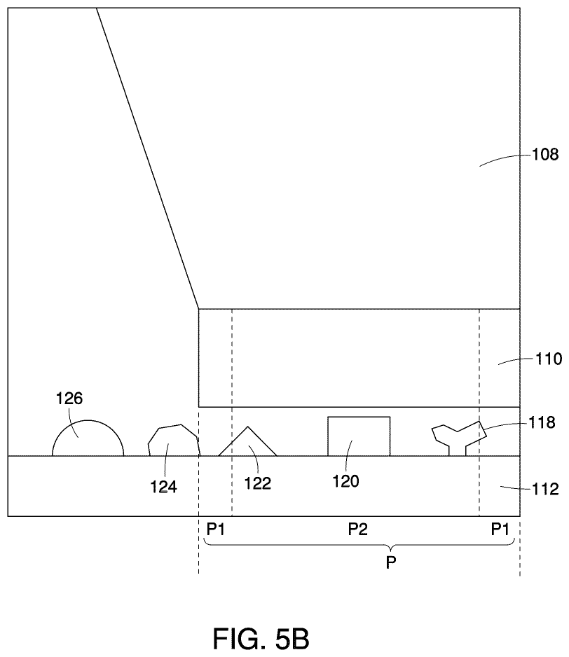

FIG. 6 shows a vehicle power system 200 according to a sixth embodiment. The vehicle power system 200 can be any suitable power system for a vehicle. For example, the vehicle power system 200 can be an e-Powertrain system for an EV.

The vehicle power system includes an engine 210 and a sound insulator 220. The engine 210 can be any suitable engine for a vehicle, in particular an engine for an EV. The sound insulator is provided above and near the engine 210. As shown in FIG. 6, some of the noise 222 generated by the engine propagates through the air, whereas other noise 224 generated by the engine is absorbed by the sound insulator. The sound insulator can be the sound insulator as described above in the first to fourth embodiments.

The sound insulator 220 can have any suitable thickness. For example, the sound insulator 220 has a thickness of 1 mm to 100 mm, preferably 5 mm to 30 mm. The sound insulator 220 has an ordered structure and is formed of a resin. The resin can be any suitable resin used in a three dimensional printing process. The resin is preferably a photopolymerizable resin that can be polymerized by light such as ultraviolet light. In particular, the photopolymerizable resin can be formed of: a nylon having a photoinitiator wavelength of 290-315 nm, an acrylic having a photoinitiator wavelength of 290-315 nm, a styrene acrylonitrile having a photoinitiator wavelength of 290-330 nm, a polycarbonate having a photoinitiator wavelength of 280-310 nm, a polystyrene having a photoinitiator wavelength of 310-325 nm, a polyethylene having a photoinitiator wavelength of 300-340 nm, a polypropylene having a photoinitiator wavelength of 290-370 nm, an ABS photopolymer having a photoinitiator wavelength of 300-385 nm, a PVC homopolymer having a photoinitiator wavelength of approximately 320 nm, a PVC copolymer having a photoinitiator wavelength of 330-370 nm, a polyurethane (aromatic) having a photoinitiator wavelength of 350-415 nm, or a mixture thereof.

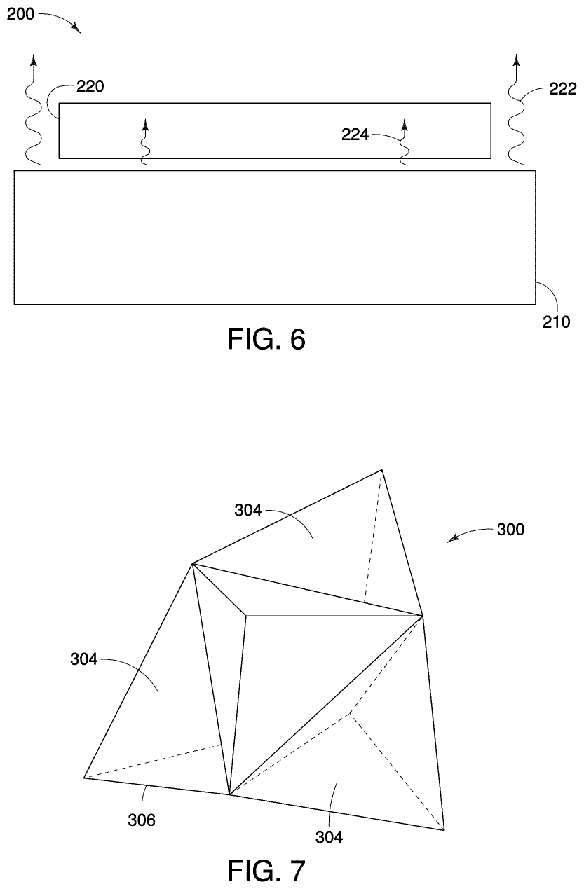

FIG. 7 shows a structure 302 that can be used to form a sound insulator according to a seventh embodiment. For example, the structure 302 can be repeated and used to form a sound insulator. The structure 302 has a polyhedron shape having a plurality of triangular faces 304. The triangular faces 304 are open faces that are not entirely bounded or closed. The structure 302 is formed by a plurality of interconnected wires 306. Each of the wires 306 is formed of a resin, such as a photopolymerizable resin as described with respect to the first to fourth embodiments. The wires 306 each have a diameter of approximately 10 μm to 1,000 μm, preferably 10 μm to 500 μm. The structure 302 can be formed by any suitable process, such as a three dimensional printing process.

Although not shown, it should be understood that structure 302 can include any one of the roughened surface described in the first embodiment, the wires having holes described in the second embodiment, the surface having holes described in the third embodiment, or the surface having the mass damper described in the fourth embodiment.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “substantially”, “about” and “approximately” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A sound insulator comprising:
a plurality of structures,
each of the plurality of structures comprising:
a plurality of interconnected wires forming a polyhedron shape having faces, and
a modified surface covering at least one of the faces, the modified surface including at least one selected from the group consisting of: a plurality of holes that extend through an entirety of a thickness of the modified surface, and a mass damper having a greater thickness than the thickness of the modified surface.

2. The sound insulator according to claim 1, wherein
the shape has eight hexagonal faces and six square faces.

3. The sound insulator according to claim 1, wherein
each of the plurality of interconnected wires has a diameter of approximately 10 μm to 1,000 μm.

4. The sound insulator according to claim 1, wherein
the thickness of the modified surface being less than a diameter of each of the plurality of interconnected wires.

5. The sound insulator according to claim 1, wherein
each of the plurality of holes has a hole diameter that ranges from 10% of a diameter of the each of the plurality of interconnected wires to 90% of a surface diameter of the modified surface.

6. The sound insulator according to claim 1, wherein
a width and depth of the mass damper are each less than 90% of a surface diameter of the modified surface.

7. The sound insulator according to claim 1, wherein
each of the plurality of interconnected wires is formed of a photopolymerizable resin material.

8. The sound insulator according to claim 1, wherein
the sound insulator has a thickness of approximately 1 mm to 100 mm.

9. The sound insulator according to claim 1, wherein
the plurality of structures are formed by a three dimensional printing process.

10. A sound insulator comprising:
a plurality of structures,
each of the plurality of structures comprising:
a plurality of interconnected wires forming a shape having eight hexagonal faces and six square faces,
at least one of the plurality of interconnected wires being a first wire having a roughened surface that includes a plurality of raised portions, and
each of the plurality of interconnected wires being formed of a photopolymerizable resin material.

11. The sound insulator according to claim 10, wherein
each of the plurality of interconnected wires has an average diameter of approximately 10 μm to 1,000 μm.

12. The sound insulator according to claim 10, wherein
the roughened surface is defined such that at least one of a minimum diameter and a maximum diameter of the first wire varies by at least 5% from an average diameter of the first wire.

13. The sound insulator according to claim 10, wherein
the sound insulator has a thickness of approximately 1 mm to 100 mm.

14. The sound insulator according to claim 10, wherein
the plurality of structures are formed by a three dimensional printing process.

15. The sound insulator according to claim 10, wherein
the first wire has a non-uniform diameter.

16. A sound insulator comprising:
a plurality of structures,
each of the plurality of structures comprising:
a plurality of interconnected wires forming a shape having eight hexagonal faces and six square faces,
at least one of the plurality of interconnected wires being a second wire having a plurality of holes that extend through an entirety of a diameter of the second wire, and
each of the plurality of interconnected wires being formed of a photopolymerizable resin material.

17. The sound insulator according to claim 16, wherein
each of the plurality of interconnected wires has a diameter of approximately 10 μm to 1,000 μm.

18. The sound insulator according to claim 16, wherein
each of the plurality of holes has a hole diameter that ranges from 10% to 90% of the diameter of the second wire.

19. The sound insulator according to claim 16, wherein
the sound insulator has a thickness of approximately 1 mm to 100 mm.

20. The sound insulator according to claim 16, wherein
the plurality of structures are formed by a three dimensional printing process.
